(19) United States
(12) Patent Application Publication
(10) Pub. No.: US 2026/0012968 A1
(43) Pub. Date: Jan. 8, 2026

(54) COMMUNICATION CONTROL METHOD AND WIRELESS COMMUNICATION SYSTEM

(71) Applicant: KYOCERA Corporation, KyotoState (JP)

(72) Inventors: Masato FUJISHIRO, Kanagawa (JP); Mitsutaka HATA, Yokohama-shi (JP)

(73) Assignee: KYOCERA Corporation, (omitted)

(21) Appl. No.: 19/323,547

(22) Filed: Sep. 9, 2025

Related U.S. Application Data
(63) Continuation of application No. PCT/JP2024/008523, filed on Mar. 6, 2024.

(30) Foreign Application Priority Data
Mar. 9, 2023 (JP) 2023-036293

(51) Int. Cl. H04W 72/51; H04W 8/18; H04W 72/0453

(52) U.S. Cl. CPC H04W 72/51; H04W 8/183; H04W 72/0453

(57) ABSTRACT

In an aspect, a communication control method is a communication control method in a wireless communication system. The communication control method includes transmitting, by a communication node to a base station, a message including first capability information indicating a capability of transmitting to a wireless tag and/or a capability of receiving from the wireless tag.

### RELATED APPLICATIONS

The present application is a continuation based on PCT Application No. PCT/JP2024/008523, filed on Mar. 6, 2024, which claims the benefit of Japanese Patent Application No. 2023-036293 filed on Mar. 9, 2023. The content of which is incorporated by reference herein in their entirety.

### TECHNICAL FIELD

The present disclosure relates to a communication control method in wireless communication systems.

### BACKGROUND

In the Third Generation Partnership Project (3GPP) (trade name, the same applies hereinafter) that is a standardization project for mobile communication systems, discussion is being made on ambient power-enabled Internet of Things (ambient IoT) (for example, see Non-Patent Document 1 to Non-Patent Document 6).

Ambient IoT is a technology that supports, for example, ultra-low cost and ultra-low power devices.

### CITATION LIST

### Non-Patent Literature

Non-Patent Document 1: 3GPP Contribution RP-222733
Non-Patent Document 2: 3GPP Contribution RP-222985
Non-Patent Document 3: 3GPP Contribution RP-223033
Non-Patent Document 4: 3GPP Contribution RP-223034
Non-Patent Document 5: 3GPP Contribution RP-223526

### SUMMARY

In a first aspect, a communication control method is a communication control method in a wireless communication system. The communication control method includes transmitting, by a communication node to a network node, a message including first capability information indicating having a capability of transmitting to a wireless tag and/or having a capability of receiving from the wireless tag.

A wireless communication system according to a second aspect is a wireless communication system including a communication node, a wireless tag, and a network node, in which the communication node transmits, to the network node, a message including first capability information indicating having a capability of transmitting to a wireless tag and/or a capability of receiving from the wireless tag.

### BRIEF DESCRIPTION OF THE DRAWINGS

FIG. 1 is a diagram illustrating a configuration example of a wireless communication system according to a first embodiment.

FIG. 2 is a diagram illustrating a configuration example of a User Equipment (UE) according to the first embodiment.

FIG. 3 is a diagram illustrating a configuration example of a gNB (base station) according to the first embodiment.

FIG. 4 is a diagram illustrating a configuration example of a wireless tag according to the first embodiment.

FIG. 5 is a diagram illustrating a configuration example of a protocol stack for a user plane according to the first embodiment.

FIG. 6 is a diagram illustrating a configuration example of a protocol stack for a control plane according to the first embodiment.

FIG. 7 is a diagram illustrating a link configuration example of a first topology according to the first embodiment.

FIG. 8 is a diagram illustrating a link configuration example of a second topology according to the first embodiment.

FIG. 9 is a diagram illustrating a link configuration example of a third topology according to the first embodiment.

FIG. 10 is a diagram illustrating a link configuration example of a fourth topology according to the first embodiment.

FIG. 11 is a diagram illustrating a link configuration example of a fifth topology according to the first embodiment.

FIG. 12 is a diagram illustrating an operation example according to the first embodiment.

FIG. 13 is a diagram illustrating an operation example according to a second embodiment.

### DESCRIPTION OF EMBODIMENTS

The present disclosure provides appropriate communication with a wireless tag in a wireless communication system.

A wireless communication system according to an embodiment is described with reference to the drawings. In the description of the drawings, the same or similar parts are denoted by the same or similar reference signs.

### First Embodiment

### Configuration Example of Wireless Communication System

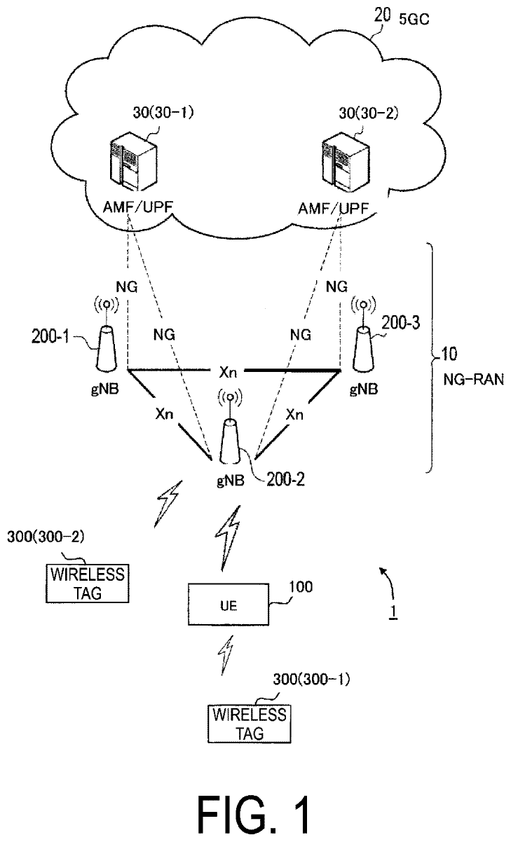

FIG. 1 is a diagram illustrating a configuration example of a wireless communication system according to a first embodiment. A wireless communication system 1 includes a mobile communication system that is the 5th Generation System (5GS) of the 3GPP standard. The description below takes the 5GS as an example of the mobile communication system, but a Long Term Evolution (LTE) system may at least partially be applied. As the mobile communication system, a sixth generation (6G) system or a subsequent generation system may at least partially be applied. Note that the wireless communication system 1 may be the mobile communication system.

The wireless communication system 1 includes a User Equipment (UE) 100, a 5G Next Generation Radio Access Network (NG-RAN) 10, a 5G Core Network (5GC) 20, and a wireless tag 300. The 5GC 20 may be hereinafter simply referred to as a core network (CN) 20.

The UE 100 is a mobile wireless communication apparatus. The UE 100 may be any apparatus as long as it is used by a user. Examples of the UE 100 include a mobile phone terminal (including a smartphone) or a tablet terminal, a notebook PC, a communication module (including a communication card or a chipset), a sensor or an apparatus provided to a sensor, a vehicle or an apparatus provided to a vehicle (Vehicle UE), and a flying object or an apparatus provided to a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. Note that a “cell” is used as a term indicating a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) 30 and a User Plane Function (UPF). The AMF 30 performs various types of mobility control and the like for the UE 100. The AMF 30 manages mobility of the UE 100 by communicating with the UE 100 by using Non-Access Stratum (NAS) signaling. The UPF controls data transfer. The AMF 30 and the UPF are connected to the gNB 200 via an NG interface, which is an interface between the base station and the core network.

The wireless tag 300 is a wireless communication apparatus capable of wireless communication with the UE 100 or the gNB 200. The wireless tag 300 is also an information medium including a built-in memory to and from which data or the like is written or read using radio waves or electromagnetic fields. The wireless tag 300 is, for example, an Internet of Things (IoT) device that is extremely small, thin, lightweight, and with low complexity.

Note that, in the first embodiment, the wireless tag 300 is an information medium that writes data or the like to or reads data or the like from a built-in memory by using a radio wave method.

Examples are illustrated in which communication destinations communicating with the wireless tag 300 are the gNB 200 and the UE 100, but in the first embodiment, a transmission source of a signal transmitted to the wireless tag 300 and a reception destination of a reflected wave of the signal transmitted to the wireless tag 300 may be different from each other. For example, there is a case that the UE 100 transmits a signal to the wireless tag 300 as the transmission source of a signal, and the gNB 200 is the reception destination of the reflected wave of the signal transmitted to the wireless tag 300. Further, for example, there is a case that the gNB 200 transmits a signal to the wireless tag 300 as the transmission source of the signal, and the UE 100 is the reception destination of the reflected wave of the signal transmitted to the wireless tag 300. Furthermore, for example, a transmission wave that the wireless tag 300 transmits may function with a signal transmitted to the wireless tag 300 as a power source (or as a trigger).

### Configuration Example of UE

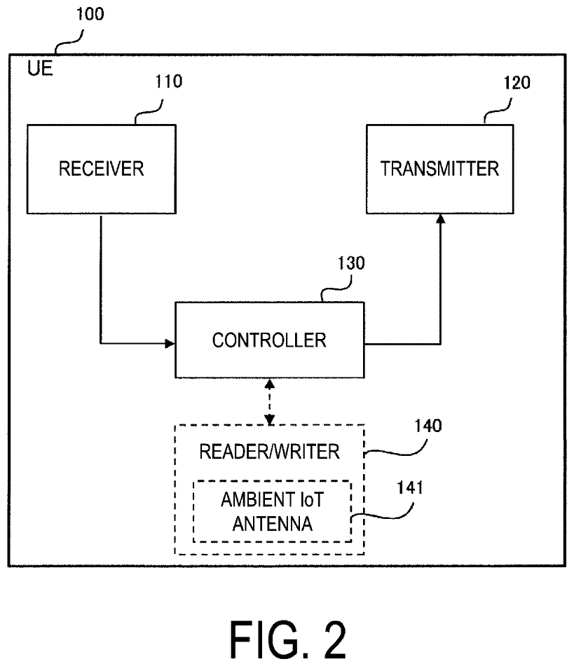

FIG. 2 is a diagram illustrating a configuration example of the user equipment 100 (UE) according to the first embodiment. The UE 100 includes a receiver 110, a transmitter 120, and a controller 130. The UE 100 may include a reader/writer 140. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. In the example described below, operations or processing in the UE 100 may be performed by the controller 130.

The reader/writer 140 includes an ambient IoT antenna 141. The reader/writer 140 communicates with the wireless tag 300 via the ambient IoT antenna 141 under control of the controller 130. The reader/writer 140 can communicate with the wireless tag 300 in a non-contact manner by using an electromagnetic field method, but in the first embodiment, the reader/writer 140 will be described as communicating with the wireless tag 300 by using a radio wave method. The reader/writer 140 can write data to or read data from the wireless tag 300. The UE 100 is capable of wireless communication with the wireless tag 300 via the reader/writer 140. Note that the reader/writer 140 may have only a reader function without a writer function. Alternatively, the reader/writer 140 may have only the writer function without the reader function. The reader/writer 140 may be omitted. When the reader/writer 140 is not provided, the wireless communication may be performed, instead of the reader/writer 140, by the transmitter 120 or the receiver 110.

The reader/writer 140 can also perform wireless communication with the wireless tag 300 using backscattering (or backward scattering). In this case, an antenna capable of transmitting and receiving a frequency signal used in the backscattering may be included in the reader/writer 140. Note that backscattering is described in detail later.

### Configuration Example of gNB

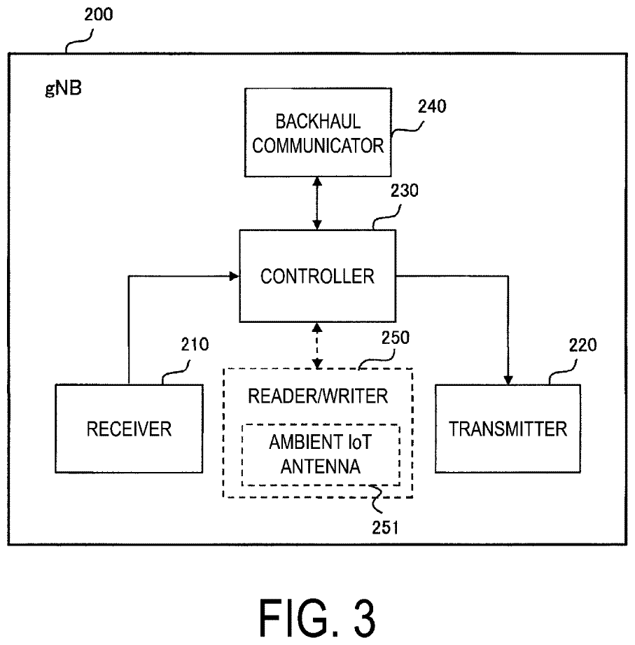

FIG. 3 is a diagram illustrating a configuration example of the gNB 200 (base station) according to the first embodiment. The gNB 200 includes a transmitter 220, a receiver 210, a controller 230, and a backhaul communicator 240. The gNB 200 may include a reader/writer 250. The transmitter 220 and the receiver 210 constitute a wireless communicator that performs wireless communication with the UE 100. The backhaul communicator 240 constitutes a network communicator that performs communication with the CN 20.

The transmitter 220 performs various types of transmission under control of the controller 230. The transmitter 220 includes an antenna and a transmission device. The transmission device converts a baseband signal (a transmission signal) output by the controller 230 into a radio signal and transmits the resulting signal through the antenna.

The receiver 210 performs various types of reception under control of the controller 230. The receiver 210 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing in the gNB 200 may be performed by the controller 230.

The backhaul communicator 240 is connected to a neighboring base station via the Xn interface which is an inter-base station interface. The backhaul communicator 240 is connected to the AMF 30/UPF via the NG interface between the base station and the core network. Note that the gNB 200 may include a Central Unit (CU) and a Distributed Unit (DU) (i.e., functions are divided), and both units may be connected via an F1 interface that is a fronthaul interface.

The reader/writer 250 includes an ambient IoT antenna 251. The reader/writer 250 communicates with the wireless tag 300 via the ambient IoT antenna 251 under control of the controller 230. The reader/writer 250 can communicate with the wireless tag 300 in a non-contact manner by using an electromagnetic field method, but in the first embodiment, the reader/writer 250 will be described as communicating with the wireless tag 300 by using a radio wave method. The reader/writer 250 can write data to or read data from the wireless tag 300. The gNB 200 is capable of wireless communication with the wireless tag 300 via the reader/writer 250. Note that the reader/writer 250 may have only the reader function without the writer function. Alternatively, the reader/writer 250 may have only the writer function without the reader function. The reader/writer 250 may be omitted. When the reader/writer 250 is not provided, the wireless communication may be performed, instead of the reader/writer 250, by the transmitter 220 or the receiver 210.

The reader/writer 250 can also perform wireless communication with the wireless tag 300 by using backscattering. In this case, an antenna capable of transmitting and receiving a frequency signal used in the backscattering may be included in the reader/writer 250.

### Configuration Example of Wireless Tag

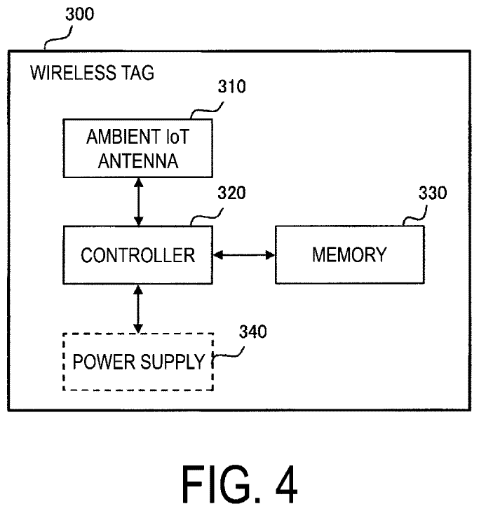

FIG. 4 is a diagram illustrating a configuration example of the wireless tag 300 according to the first embodiment. The wireless tag 300 includes an ambient IoT antenna 310, a controller 320, and a memory 330. The wireless tag 300 may include a power supply 340.

The ambient IoT antenna 310 performs wireless communication with the UE 100 or the gNB 200 by using a Radio Frequency identifier (RFID) technology. As described above, the RFID technology includes a radio wave method and an electromagnetic field method.

The radio wave method is a type of transmitting energy and signals using radio waves. In this case, the ambient IoT antenna 310 receives a radio wave transmitted from the UE 100 or the gNB 200, and a rectifier circuit provided in the ambient IoT antenna 310 outputs part of the radio wave to the controller 320 as a DC power supply. This causes the controller 320 to operate. The wireless tag 300 may perform data transmission, for example, as follows. That is, for the ambient IoT antenna 310, the controller 320 controls the reflectance of the reflected wave of a transmission wave from the UE 100 or the gNB 200. The ambient IoT antenna 310 may modulate the reflected wave by changing the reflectance of the reflected wave in accordance with the reflectance, and perform data transmission. As described above, the ambient IoT antenna 310 transmits the radio signal by using the reflected wave of an unmodulated transmission wave transmitted from the UE 100 or the gNB 200. In the UE 100 or the gNB 200, by demodulating the modulated signal included in the reflected wave, the data transmitted from the wireless tag 300 can be obtained. Communication by using a reflected wave in this manner is referred to as backscattering communication, for example. Note that the ambient IoT antenna 310 may convert a transmission signal received from the controller 320 into a radio signal of a radio band by a modulation circuit or the like provided in the ambient IoT antenna 310, and transmit the radio signal to the UE 100 or the gNB 200.

The controller 320 receives a reception signal from the ambient IoT antenna 310. For example, the controller 320 writes data included in the reception signal to the memory 330 in accordance with indication information included in the reception signal. The controller 320 reads data from the memory 330 in accordance with the indication information included in the reception signal, for example. The controller 320 outputs a transmission signal including the data that is read to the ambient IoT antenna 310. In the example described below, operations or processing in the wireless tag 300 may be performed by the controller 320.

The memory 330 stores an identifier of the wireless tag 300 (or identification information of the wireless tag 300. Hereinafter, the “identifier” and the “identification information” are not distinguished from each other in some cases), data, and the like. The memory 330 of the wireless tag 300 may adopt the Electronic Product Code (EPC) Class 1 Generation 2 (GEN2) standard conforming to ISO/IEC 18000-63. The memory 330 of the EPC GEN2 standard has four memory areas of a USER memory, a Tag ID (TID) memory, an EPC memory, and a RESERVED memory. The USER memory is an area that can be freely written to and read from by a user using the wireless tag 300. The TID memory is an area that a manufacturer, model information, and the like of the wireless tag 300 are written. The TID memory is a readable and non-writable area. The EPC memory is an area that the identifier of the wireless tag 300 is written. The RESERVED memory is an area that password information of the wireless tag 300 is written. The password information includes password information used to lock writing to the wireless tag 300 and password information used to Kill the wireless tag 300.

The power supply 340 is, for example, a power supply using energy harvesting. An environment for harvesting includes heat, vibration, motion, light, wind, radio wave, or biotechnology. The energy harvesting is a power generation method in which an electromotive force is obtained from the surrounding environment as described above. The energy harvesting is different from a power generation method using a battery such as a secondary battery. However, the wireless tag 300 may be equipped with a battery to generate power by itself like an active tag. For this reason, the power supply 340 may be a battery power supply.

Note that the wireless tag 300 may have only the reader function of reading data or the like from the memory 330 without the writer function of writing data or the like to the memory 330.

The wireless tag 300 can also perform wireless communication with the UE 100 or the gNB 200 using a communication protocol in accordance with the 3GPP. In this case, instead of the ambient IoT antenna 310, an antenna capable of transmitting and receiving a radio signal having a frequency used for the 3GPP may be included in the wireless tag 300.

Hereinafter, transmission of an unmodulated transmission wave from a communication node to the wireless tag 300 may be referred to as “CW transmission”. Further, hereinafter, the reception of a reflected wave from a wireless tag in response to the transmission wave by the communication node may be referred to as “BS reception”.

### Protocol Stack

A configuration example of the protocol stack is described. Here, a configuration example of the protocol stack in the UE 100, the gNB 200, and the AMF 30 other than the wireless tag 300 is described.

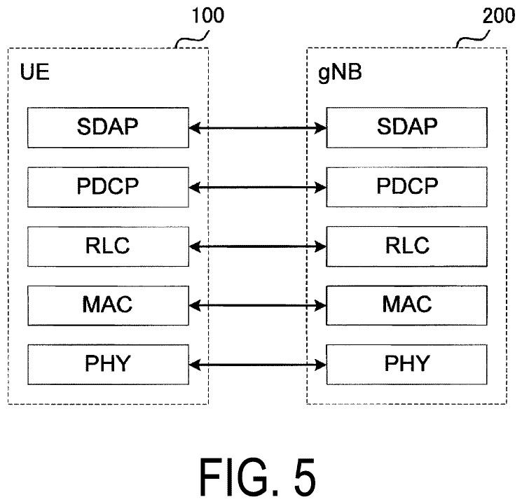

FIG. 5 is a diagram illustrating a configuration example of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. A Cyclic Redundancy Code (CRC) parity bit scrambled by the RNTI is added to the DCI transmitted from the gNB 200.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression and decompression, encryption and decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

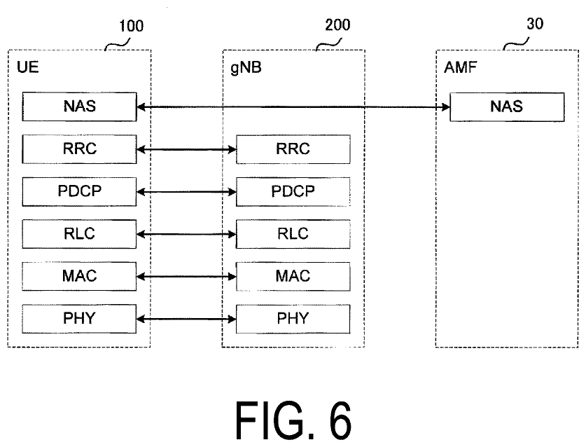

FIG. 6 is a diagram illustrating a configuration example of a protocol stack of a radio interface of a control plane handling signaling (a control signal).

The protocol stack of the radio interface of the control plane includes a Radio Resource Control (RRC) layer and a Non-Access Stratum (NAS) instead of the SDAP layer illustrated in FIG. 5.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 30. Note that the UE 100 includes an application layer other than the protocol of the radio interface. A layer lower than the NAS is referred to as an Access Stratum (AS).

### Ambient IoT

The ambient IoT is, for example, a device with low power consumption and low complexity. The ambient IoT supports communication with a reader by reflection or transmission, and can support with very low complexity hardware. The ambient IoT can collect energy from the environment, such as an RF signal, solar energy, vibration, or heat. The ambient IoT can be equipped with a small capacity battery. The ambient IoT is also a technology capable of further reduction of a cost as compared with existing cellular IoT such as NB-IoT, LTE-M, and RedCap.

An ambient IoT device to support the ambient IT may be a very simple device that purely has no energy storage capability (i.e., a passive device). Alternatively, the ambient IoT device may be a device that has limited energy storage capability without necessity to be manually replaced or charged. Alternatively, the ambient IoT device may be an active device that has energy storage capability. In a case of a passive device, the ambient IoT device can obtain energy from an external source and communicate by using backscattering communication.

### Agreements on Ambient IoT Device

Next, agreements on the ambient IoT device in the 3GPP will be described.

### (1.1) Ambient IoT Device Type

In the 3GPP, there are agreements on types of an ambient IoT device.

First, an ambient IoT device does not have a power supply and does not independently generate a signal. Such ambient IoT device is referred to as a “device A”. The device A can transmit a signal by backscattering. That is, the device A is a device capable of supplying power with energy harvesting, and functions as a passive device.

Second, the ambient IoT device has a small capacity power supply such as a capacitor and does not independently generate a signal. Such ambient IoT device is referred to as a “device B”. The device B can not only transmit a signal by backscattering but also amplify the signal during the backscattering.

Third, an ambient IoT device has a power supply and independently generates a signal. Such ambient IoT device is referred to as a “device C”. The device C can transmit a waveform that is normally generated by using an active component for transfer.

Hereinafter, the ambient IoT device may be referred to as the wireless tag 300.

### (1.2) Connection Form (Topology) of Ambient IoT Device

Also, in the 3GPP, there are agreements on connection forms (that is, topology) for an ambient IoT device.

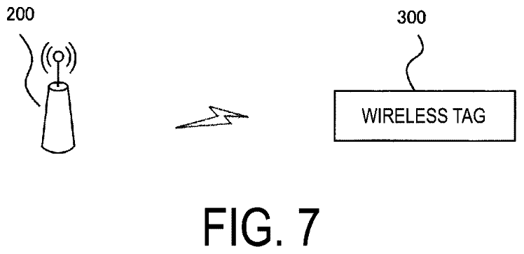

First, there is a topology (topology (1)) in which the gNB 200 and the wireless tag 300 directly communicate with each other. FIG. 7 is a diagram illustrating a link configuration example of a first topology (topology (1)) according to the first embodiment. Note that, in the example of FIG. 7, the first topology illustrating an example, in which the same gNB 200 communicates with the wireless tag 300, may include a case that a gNB 200-1 on a transmission side and a gNB 200-2 on a reception side are different from each other. That is, there is a case that transmission to and reception from the wireless tag 300 are performed by different gNBs 200.

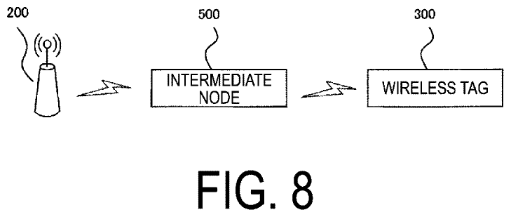

Second, there is a topology (topology (2)) in which the gNB 200 and the wireless tag 300 communicate with each other via an intermediate node 500. FIG. 8 is a diagram illustrating a link configuration example of a second topology (topology (2)) according to the first embodiment. Note that the intermediate node 500 may be a relay node. The relay node is, for example, a relay base station that is interposed between the UE 100 and the gNB 200 and relays communication between the UE 100 and the gNB 200. Alternatively, the intermediate node 500 may be an IAB node. The IAB node is, for example, a communication node that communicates with the UE 100 via an access communication link, and communicates with the gNB 200 (or a donor node) or another IAB node via a wireless backhaul communication link. Alternatively, the intermediate node 500 may be a repeater. The repeater is an example of a relay node that relays a radio signal between the network and the UE 100, and is an apparatus that can control the relay of a radio signal from the network. The repeater may be referred to as an NCR apparatus.

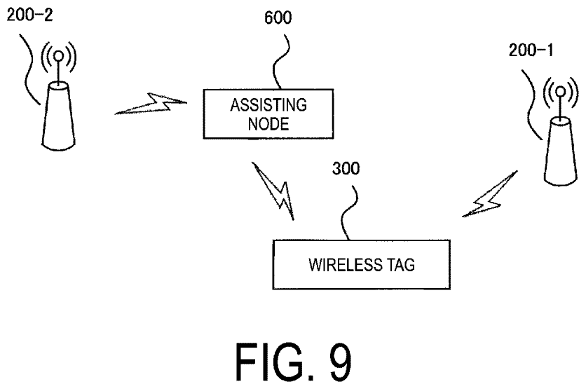

Third, there is a topology (topology (3)) in which the gNB 200 and the wireless tag 300 communicate with each other via an assisting node. FIG. 9 is a diagram illustrating a link configuration example of a third topology (topology (3)) according to the first embodiment. As illustrated in FIG. 9, there is a case that the transmission source of the wireless tag 300 is the assisting node 600 and the reception destination of the wireless tag 300 is the gNB 200. Further, there is a case that the transmission source of the wireless tag 300 is the gNB 200 and the reception destination of the wireless tag 300 is the assisting node 600. As described above, the assisting node 600 assists either the CW transmission to or the BS reception from the wireless tag 300, thereby performing communication with the wireless tag 300. Note that the assisting node 600 may be any of the IAB node, the UE 100, or a repeater node. Although the example of FIG. 9 illustrates an example in which the gNB 200 that directly communicates with the assisting node 600 and the gNB 200 that directly communicates with the wireless tag 300 are the same gNB 200, the gNB 200 that directly communicates with the assisting node 600 and the gNB 200 that directly communicates with the wireless tag 300 may be different gNBs.

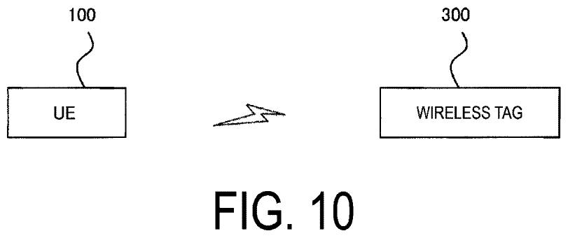

Fourth, there is a topology (topology (4)) in which the UE 100 directly communicates with the wireless tag 300. FIG. 10 is a diagram illustrating a link configuration example of a fourth topology (topology (4)) according to the first embodiment. Note that the example of FIG. 10 illustrates an example in which the same UE 100 communicates with the wireless tag 300. The fourth topology includes a case that the UE 100 on the transmission side and the UE 100 on the reception side are different from each other. That is, there is a case that transmission to and reception from the wireless tag 300 are performed by the different UEs 100.

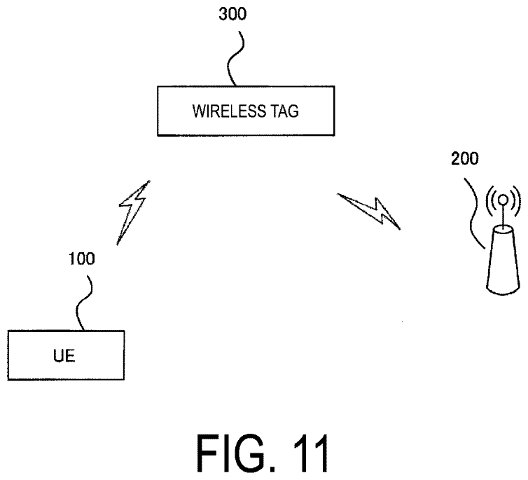

Fifth, there is a topology (topology (5)) in which the UE 100 and the gNB 200 are connected via the wireless tag 300. FIG. 11 is a diagram illustrating a link configuration example of a fifth topology (topology (5)) according to the first embodiment. As illustrated in FIG. 11, in the fifth topology, the transmission source node and the reception destination node of the wireless tag 300 are different from each other. That is, there is a case that the transmission source of the wireless tag 300 is the UE 100 and the reception destination is the gNB 200. Further, there is a case that the transmission source of the wireless tag 300 is the gNB 200 and the reception destination is the UE 100.

In the above, pieces of the topology have been described. In any topology, the communication direction may be unidirectional. The communication direction may be bidirectional.

### Communication Control Method According to First Embodiment

As described above, in the first embodiment, the communication node as the transmission source to the wireless tag 300 and the communication node as the reception destination from the wireless tag 300 may be different. The gNB 200 may be able to appropriately configure the communication node for communication with the wireless tag when the gNB 200 can recognize what kind of capability the communication node has for the wireless tag 300, that is, whether the communication node has a capability of transmitting to the wireless tag 300, a capability of receiving from the wireless tag 300, or both a capability of transmitting to and a capability of receiving from the wireless tag 300.

The first embodiment provides appropriate communication with the wireless tag 300 in the wireless communication system 1.

In the first embodiment, therefore, a communication node (for example, the UE 100) transmits, to a base station (for example, gNB 200), a message including first capability information indicating having a capability of transmitting to a wireless tag (for example, the wireless tag 300) and/or having a capability of receiving from the wireless tag.

Accordingly, for example, the gNB 200-1 can recognize the capability of the communication node for the wireless tag 300, and thus the gNB 200-1 can appropriately perform the configuration of the communication node for the wireless tag 300. Thus, the wireless communication system 1 can achieve appropriate communication with the wireless tag 300.

First, the first capability information may represent having a capability of transmitting to the wireless tag 300 and/or having a capability of receiving from the wireless tag 300. Specifically, the first capability information may be either of having a capability of transmitting of CW transmission to the wireless tag 300 or having a capability of receiving of BW reception from the wireless tag 300. Here, having the capability of transmitting of the CW transmission may include that the communication node has the capability of transmitting of the CW transmission and does not have the capability of receiving of the BS reception. Further, having the capability of receiving of the BS reception may include that the communication node has the capability of receiving of the BS reception and does not have the capability of transmitting of the CW transmission.

Second, the first capability information may include first frequency information supporting the CW transmission and/or second frequency information supporting the BS reception. The first frequency information may include bandwidth information used for the CW transmission, and the second frequency information may include bandwidth information used for the BS reception. Note that, when multiple frequencies are supported, a combination of frequencies that can simultaneously be used may be included in the first capability information.

Third, the first capability information may include topology information indicating whether at least any of the first topology to the fifth topology is supported in the communication node. For example, the first capability information may include topology information indicating that both the fourth topology and the fifth topology are supported.

Fourth, the first capability information may include information on a node category. The information on the node category may be, for example, information indicating having a capability as the intermediate node 500. The intermediate node 500 is, for example, a node that directly communicates with the wireless tag 300 in the second topology. In this case, the communication node of the transmission source of the wireless tag 300 and the communication node of the reception destination of the wireless tag 300 are the same intermediate node 500. The information on the node category may be, for example, information indicating having a capability as an assisting node 600. The assisting node 600 is, for example, a node that directly communicates with the wireless tag 300 in the third topology. The assisting node 600 may be, for example, a node that performs the CW transmission or the BS reception.

Fifth, the first capability information may include information related to the communication direction. The information on the communication direction may be information indicating being unidirectional in the communication with the wireless tag 300. The information related to communication direction may be, for example, information indicating being bidirectional in the communication with the wireless tag 300.

### First Operation Example According to First Embodiment

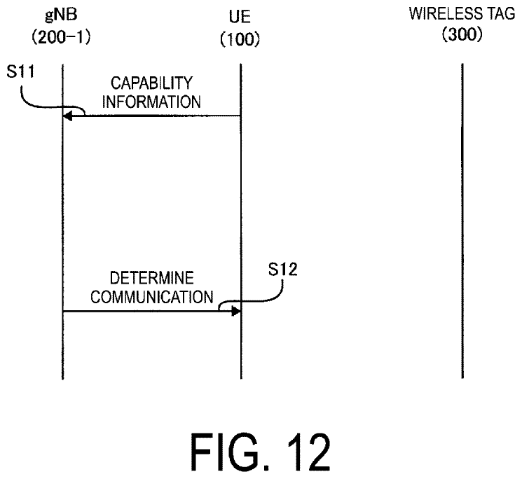

FIG. 12 is a diagram illustrating a first operation example according to the first embodiment. Note that in the operation example of FIG. 12, an example will be described in which the UE 100 is the communication node. The UE 100 is RRC connected with the gNB 200-1 and is in the RRC connected state.

In step S11, the UE 100 notifies the gNB 200-1 of the capability information of the UE 100 itself. Specifically, the UE 100 transmits a message including the first capability information to the gNB 200-1. The message may be an RRC message such as a UE Capability Information message or the like. The message may be another RRC message. The message may be a new message in a layer newly provided for the ambient IoT.

In step S12, the gNB 200-1 determines to perform communication with the wireless tag 300. For the UE 100, the gNB 200-1 may perform configuration related to communication with the wireless tag 300.

### Other Operation Example 1 According to First Embodiment

In the first embodiment, the UE 100 and the neighboring gNB 200-2 are described as examples of the communication node, but the communication node is not limited to the UE 100 and the neighboring gNB 200-2.

The communication node may be the IAB-MT instead of the UE 100. The IAB-MT is a functional block of a portion having a terminal function in the IAB node. The IAB-MT has a function the same and/or similar to that of the UE 100. In this case, the IAB-MT transmits the capability information for the wireless tag 300 to the gNB 200. The type of the capability information may be the same as that of the first capability information. In this case, the capability information of the IAB-MT for the wireless tag 300 may be represented by replacing the “UE 100” with the “IAB-MT” in the first capability information. With the IAB-MT in the RRC connected state with the gNB 200 transmitting an RRC message including the capability information to the CU of the gNB 200 (i.e., an IAB-donor-CU), the capability information may be notified to the gNB 200. Alternatively, an IAB-DU of the IAB node may acquire the capability information from the IAB-MT, and the IAB-DU may transmit an F1 message including the capability information to the IAB-donor-CU.

### Other Operation Example 2 According to First Embodiment

The communication node may be a Network-controlled Repeater-Mobile Terminal (NCR-MT) included in an NCR apparatus instead of the UE 100. The NCR apparatus is an example of a relay node that relays a radio signal between the network and the UE 100, and is also an example of a repeater apparatus that can be controlled from the network. The NCR apparatus is capable of, for example, amplifying a radio signal received from the gNB 200 without demodulating and modulating, and transmitting the amplified radio signal to the UE 100 by directional transmission. The NCR-MT is a block that is included in the NCR apparatus, establishes a wireless connection with the gNB 200, and functions as a control terminal that controls the relay of the NCR apparatus together with the gNB 200. The NCR-MT has a function the same and/or similar to that of the UE 100.

When the communication node is the NCR-MT, the NCR-MT transmits the capability information of its own for the wireless tag 300 to the gNB 200. The type of the capability information may be the same as that of the first capability information. In this case, the capability information of the NCR-MT for the wireless tag 300 may be represented by replacing the “UE 100” with the “NCR-MT” in the first capability information. With the NCR-MT in the RRC connected state with the gNB 200 transmitting an RRC message including the capability information to the gNB 200, the capability information may be notified to the gNB 200.

### Other Operation Example 3 According to First Embodiment

The communication node may be a relay node instead of the neighboring gNB 200-2. In this case, the relay node transmits the capability information for the wireless tag 300 of its own to the gNB 200-1. The type of the capability information may be the same as that of the second capability information. In this case, the capability information of the relay node for the wireless tag 300 may be represented by replacing the “neighboring gNB 200-2” with the “relay node” in the second capability information. The relay node may transmit the capability information to the gNB 200-1 by using an Xn message.

### Other Operation Example 4 According to First Embodiment

The communication node may be a DU in the gNB 200-1 instead of the neighboring gNB 200-2. In this case, the DU notifies a CU in the gNB 200-1 of the capability information for the wireless tag 300. The type of the capability information may be the same as that of the second capability information. The capability information of the DU for the wireless tag 300 may be represented by replacing the “neighboring gNB 200-2” with the “DU” in the second capability information. By transmitting the F1 message including the capability information to the CU in the gNB 200-1, the DU in the gNB 200-1 may notify the CU of the capability information of the DU.

### Other Operation Example 5 According to First Embodiment

The communication node may be the DU of the gNB 200-1 being a donor node for the IAB node (i.e., IAB-donor-DU) instead of the neighboring gNB 200-2. In this case, the IAB-donor-DU notifies the CU in the gNB 200-1 (i.e., the IAB-donor-CU) of the capability information for the wireless tag 300. The type of the capability information may be the same as that of the second capability information. The capability information of the IAB-donor-DU for the wireless tag 300 may be represented by replacing the “neighboring gNB 200-2” with the “IAB-donor-DU” in the second capability information. By transmitting the F1 message including the capability information to the IAB-donor-CU, the IAB-donor-DU may notify the IAB-donor-CU of the capability information of the IAB-donor-DU.

### Second Embodiment

Next, a second embodiment will be described.

In the first embodiment, an example has been described in which the communication node is the UE 100, whereas in the second embodiment, an example will be described in which the communication node is other than the UE 100, for example, the neighboring gNB 200-2.

Specifically, in the second embodiment, a communication node (for example, the neighboring gNB 200-2) transmits, to a base station (for example, gNB 200), a message including the second capability information indicating having a capability of transmitting to a wireless tag (for example, the wireless tag 300) and/or having a capability of receiving from the wireless tag.

Accordingly, for example, the gNB 200-1 can recognize the capability of the communication node for the wireless tag 300, and thus the gNB 200-1 can appropriately perform the configuration of the communication node for the wireless tag 300.

First, the second capability information includes capability information of the neighboring gNB 200-2 for the wireless tag 300. The type of the capability information may be the same as that of the first capability information. That is, the first capability information represents the capability information of the UE 100 for the wireless tag 300, whereas the second capability information may be represented by replacing the “UE 100” with the “neighboring gNB 200-2” in the first capability information.

Second, the second capability information may be transmitted with an Xn message. The neighboring gNB 200-2 may transmit a gNB Configuration Update message including the second capability information to the gNB 200-1. The neighboring gNB 200-2 may transmit the message by using another Xn message.

### Operation Example According to Second Embodiment

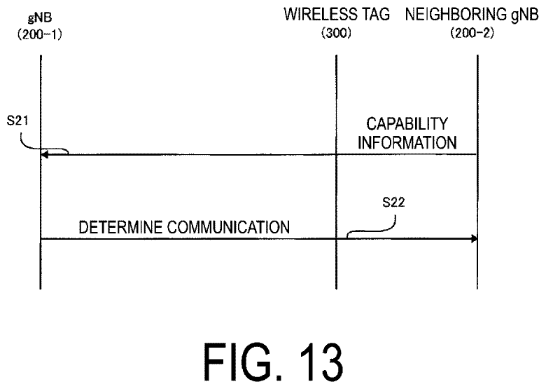

FIG. 13 is a diagram illustrating an operation example according to the second embodiment. Note that, in the operation example of FIG. 13, an example will be described in which the neighboring gNB 200-2 is the communication node.

In step S21, the neighboring gNB 200-2 notifies the capability information of the neighboring gNB 200-2 itself for the wireless tag 300. Specifically, the neighboring gNB 200-2 transmits a message including the second capability information to the gNB 200-1.

In step S22, the gNB 200-1 determines to perform communication with the wireless tag 300. The gNB 200-1 may perform configuration (or request) related to communication with the wireless tag 300 to the neighboring gNB 200-2.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processes performed by the UE 100, the gNB 200, or the AMF 30 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM.

Circuits for executing each of the processes performed by the UE 100, the gNB 200, or the AMF 30 may be integrated, and at least part of the UE 100, the gNB 200, or the AMF 30 may be configured as a semiconductor integrated circuit (a chipset or a System on a Chip (SoC)).

The functions achieved by the UE 100, the gNB 200, or the AMF 30 may be implemented in circuitry or processing circuitry including general purpose processors and special purpose processors that are programmed to achieve the described functions, integrated circuits, application specific integrated circuits (ASICs), a central processing unit (CPU), conventional circuits, and/or combinations thereof. The processor includes a transistor and other circuits, and is considered as circuitry or processing circuitry. The processor may be a programmed processor that executes a program stored in a memory. In the present description, circuitry, units, means are hardware programmed to achieve or hardware to execute the described functions. The hardware may be any hardware disclosed in the present description, any hardware programmed to achieve or known to execute the described functions. When the hardware is a processor considered to be a type of circuitry, the circuitry, means, or units are a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### Supplements

### Supplementary Note 1

A communication control method in a wireless communication system, the communication control method including: transmitting, by a communication node to a network node, a message including first capability information indicating having a capability of transmitting to a wireless tag and/or having a capability of receiving from the wireless tag.

### Supplementary Note 2

The communication control method according to Supplementary Note 1, in which
the capability of transmitting is a capability of the communication node to transmit a transmission wave including an unmodulated wave to the wireless tag,
the capability of receiving is a capability of the communication node to receive a reflected wave for the unmodulated wave from the wireless tag, and
the reflected wave includes a modulated wave obtained by modulating data stored in the wireless tag.

### Supplementary Note 3

The communication control method according to Supplementary Note 2, in which the first capability information includes first frequency information used for transmission of the transmission wave and/or second frequency information used for reception of the reflected wave.

### Supplementary Note 4

The communication control method according to Supplementary Note 1, further including: transmitting, by a neighboring network node neighboring the network node, a message to the network node, the message including second capability information indicating having the capability of transmitting to the wireless tag or having the capability of receiving from the wireless tag.

### Supplementary Note 5

The communication control method according to Supplementary Note 1, in which the communication node is a user equipment, an IAB-MT of an IAB node, a Relay-node, or a Repeater of an NCR.

### Supplementary Note 6

A wireless communication system including:
a communication node;
a wireless tag; and
a network node,
in which the communication node transmits, to the network node, a message including first capability information indicating having a capability of transmitting to the wireless tag and/or having a capability of receiving from the wireless tag.

### REFERENCE SIGNS

1: Wireless communication system
10: NG-RAN
20: 5GC (CN)
30: AMF
100: UE
110: Receiver
120: Transmitter
130: Controller
140: Reader/writer
141: Ambient IoT antenna
200: gNB
210: Receiver
220: Transmitter
230: Controller
250: Reader/writer
251: Ambient IoT antenna
300: Wireless tag
310: Ambient IoT antenna
320: Controller
330: Memory
340: Power supply
500: Intermediate node
600: Assisting node

1. A communication control method in a wireless communication system, the communication control method comprising:
transmitting by a communication node to a network node, a message comprising first capability information indicating having a capability of transmitting to a wireless tag and/or having a capability of receiving from the wireless tag.

2. The communication control method according to claim 1, wherein
the capability of transmitting is a capability of the communication node to transmit a transmission wave comprising an unmodulated wave to the wireless tag,
the capability of receiving is a capability of the communication node to receive a reflected wave for the unmodulated wave from the wireless tag, and
the reflected wave comprises a modulated wave obtained by modulating data stored in the wireless tag.

3. The communication control method according to claim 2, wherein
the first capability information comprises first frequency information used for transmission of the transmission wave and/or second frequency information used for reception of the reflected wave.

4. The communication control method according to claim 1, further comprising:
transmitting, by a neighboring network node neighboring the network node, a message to the network node, the message comprising second capability information indicating having the capability of transmitting to the wireless tag or having the capability of receiving from the wireless tag.

5. The communication control method according to claim 1, wherein
the communication node is a user equipment, an IAB-MT of an IAB node, a Relay-node, or a Repeater of an NCR.

6. A wireless communication system comprising:
a communication node;
a wireless tag; and
a network node,
wherein the communication node transmits, to the network node, a message comprising first capability information indicating having a capability of transmitting to the wireless tag and/or having a capability of receiving from the wireless tag.

7. A communication node used in a wireless communication system, the communication node comprising:
a transmitter configured to transmit to a network node, a message comprising first capability information indicating having a capability of transmitting to a wireless tag and/or having a capability of receiving from the wireless tag.
